(19) United States
(12) Patent Application Publication
(10) Pub. No.: US 2012/0038157 A1
(43) Pub. Date: Feb. 16, 2012

(54) Synchronous Induced Wind Power Generation System

(76) Inventor: James A. Skala, Hartselle, AL (US)

(21) Appl. No.: 13/280,634

(22) Filed: Oct. 25, 2011

Related U.S. Application Data
(63) Continuation-in-part of application No. 12/888,647, filed on Sep. 23, 2010.
Application No. 12/888,647 is a continuation-in-part of application No. 12/713,140, filed on Feb. 25, 2010.

(51) Int. Cl. H02P 9/04

(52) U.S. Cl. 290/44

(57) ABSTRACT

A synchronous induced wind power generation system is provided, comprised of a horizontally rotatable turbine-generator section that wind vanes into the prevailing wind direction. The turbine-generator section has a horizontally disposed turbine shaft therein, and air induction shrouds at either end thereof, the anterior areas of the air induction shrouds having larger areas than the interior area of the turbine-generator section, so as to induce a larger differential air pressure across the turbine. The turbine is directly coupled to a synchronous AC generator that is synchronized with an external power line in connection therewith, and directly generates synchronous AC power. Further, turbine magnetic brakes and/or adjustable pitch directrix blades are employed to control the speed of rotation of the turbine 1) during synchronization with the electrical line, 2) to modulate turbine power, and 3) to protect against overspeed during high wind and loss of load.

### REFERENCE TO A RELATED APPLICATION

This application is a CIP (continuation-in-part) patent application of copending U.S. patent application Ser. No. 12/888,647, filed Sep. 23, 2010, which is a CIP of copending U.S. patent application Ser. No. 12/713,140, filed Feb. 25, 2010, the contents of both of which are incorporated herein by reference.

### BACKGROUND OF THE INVENTION

1. Field of the Invention

A synchronous induced wind power generation system is provided, which is comprised of a direct-coupled turbine-generator section on a horizontally rotatable gimbal that allows it to wind-vane into the prevailing wind. In particular, a wind powered synchronous electrical generation system is provided having a turbine-generator section with a horizontally disposed rotating shaft therein connecting the turbine to the generator, air inlet and air discharge shrouds formed thereon so as to induce higher differential air pressure across the turbine, turbine brakes and adjustable pitch directrix blading to control the rotational speed of the turbine and the shaft power delivered to the synchronous generator, and a control system operable to control the turbine brakes, directrix blading pitch and the synchronous generator.

2. Description of the Related Art

Wind as an alternate motive force for generating electricity has long provided an attractive alternative to conventional power generation techniques. However, the effectiveness of conventional wind power generation systems have been limited by various difficulties such as, for example, the inconsistency of the wind, appropriate locations for placement of wind power generation system far from load centers and the problems of long distance transmission of power, difficulty in repair and maintenance of large systems, etc. These difficulties have inhibited large scale adoption of wind power as an alternate means of energy.

With regards to appropriate locations to place the systems, generally, wind power systems using turbines are developed, built and installed by large power companies, and are generally large units with very long turbine blades. The generator is mounted within a housing or nacelle that is positioned on top of a truss or tubular tower. The turbine blades transform wind energy into a rotational force or torque that drives a generator through a gearbox that steps the speed of the generator up to around 1200 RPM. The generator is usually a DC generator, and produces DC power in proportion to a variable wind speed. The DC power is run through an inverter to get AC power, and the AC power is delivered to the power grid for sale.

The power companies that install such wind turbines are generally interested in systems capable of generating large amounts of power. Thus, most current wind turbines use large-sized blades (e.g., 60 meters or more in length). These large size blades result in an economy of scale. However, the longer blades require a supporting tower having a corresponding increased height and size.

Further, such large size blades prevent placement of conventional wind turbines within urban/suburban environments where the greatest demand for energy exists. Moreover, the large wind turbines are more subject to damage from high winds, as well as structural fatigue failures. Namely, the blades are subject to fatigue by encountering significantly higher wind loads at the top of the arc of rotation, followed a second later by lower velocity wind loads, which culminate at the bottom of the arc of rotation as the blade passes the supporting column, where the flow of air is disrupted.

To minimize the chance that such conventional wind turbines are damaged by high winds, conventional wind turbines are shut down when winds exceed a predetermined speed. And, the large blades with high tip velocities sometimes strike birds, resulting in conflict with environmental groups.

In view of the deficiencies of conventional wind turbines discussed above, it is an object of the present invention to provide a wind driven electricity generating system that can be run safely at 100% load regardless of higher wind speeds, that results in distributed power generation by use of many small wind generators inside load centers, that do not strike birds, that have no problem with blade failures, and that directly generate synchronous AC power (no inverter needed), thus replacing retail power.

It is a further object of the present invention to provide a wind driven electricity generating system that is structurally unobtrusive so as to be installable in urban/suburban environments close to or at the source of power consumption, thereby negating the need for expensive and inefficient power transmission lines.

### BRIEF SUMMARY OF THE INVENTION

In order to achieve the objects of the present invention, the present inventors endeavored to develop a synchronous induced wind powered generation system capable of generating synchronous and consistent AC power regardless of high wind velocity or direction, and which may be installed in various locations, including urban and suburban environments. Accordingly, in a first embodiment of the present invention, a synchronous induced wind power generation system is provided comprising:

(a) a turbine-generator section comprised of an outer shell having a first end, a second end opposite the first end, an interior area disposed there between, an air inlet shroud disposed at the first end, an air discharge shroud disposed at the second end, a horizontal wind flow axis extending from the air inlet shroud to the air discharge shroud, and a vertical axis of rotation disposed perpendicular to the wind flow axis;

(b) one or more turbine/generator units disposed within the interior area of the turbine-generator section at or between the air inlet shroud and air discharge shroud, each of said turbine/generator units comprised of:
(i) a horizontally disposed rotatable shaft having a first end and a second end;
(ii) one or more turbine blades disposed in a plane perpendicular to the rotatable shaft and in connection with the first end of the rotatable shaft, each of said turbine blades having one or more outer tips;
(iii) a synchronous generator in communication with the second end of the rotatable shaft;
(iv) one or more turbine magnetic brake rotor(s) disposed on one or more turbine blade outer tips;
(v) one or more adjustable pitch directrix blades disposed in a plane parallel to the one or more turbine blades; and
(vi) one or more slip rings (which may be any conventional slip ring) disposed on or adjacent to a direction orientation means support pedestal, said slip rings operable to commutate the 3-phase AC power switch of the turbine-generator section to an external AC power line;

(c) a control system in conductive communication with each synchronous generator operable to synchronize the frequency, phase and voltage of the synchronous generator with the frequency, phase and voltage of an external AC power line in conductive communication with the synchronous generator, and in conductive or mechanical communication with the turbine magnetic brakes and adjustable pitch directrix bladinges so as to be operable to control the speed of rotation with no load, or maximum torque during synchronous operation of the turbine, thereby controlling shaft power delivered to the generator, said control system comprised of:
(i) a computer processor;
(ii) one or more of a phase sensor and speed sensor in connection with the computer processor and each of the turbine/generator units;
(iii) one or more electromagnets disposed adjacent to the magnetic brake rotor and in communication with the computer processor;
(iv) one or more permanent magnets removably disposed on the turbine generator section adjacent a periphery thereof and the magnetic brake rotor, and in communication with the computer processor;
(v) a servo controller in communication with the computer processor and the adjustable pitch directrix blades, the servo controller operable to vary the pitch of the adjustable pitch directrix blades;
(vi) one or more voltage, current, frequency and phase sensors in communication with the external AC power line so as to measure the voltage, current, frequency and phase thereof
(vii) a 3 phase AC power switch in communication with the computer processor, said switch operable to open or close the AC connection between the generator and the external power line; and
(viii) a voltage regulator in communication with the computer processor, said voltage regulator operable to adjust the field current in the generator.

The permanent magnets are preferably capable of providing braking power equivalent to the maximum rated wind speed of the system, such that with the permanent magnets in place, the system will not be damaged by winds up to the maximum wind rating with the generator off line and unattended. Further, the turbine-generator section aligns itself with the prevailing wind direction by wind vane action, with rotation about a pivot on a central pedestal, and is preferably supported by wheels on a circular track that surrounds the entire device.

The pitch of the directrix blading is preferably capable of being adjusted to both increase or decrease the torque output of the turbine, and in the case of severely high wind speeds, to reduce the turbine torque to near zero when needed, thus allowing wind to pass through the turbine without taking much energy from it when the unit is disconnected from the load. The pitch of the adjustable directrix blades may be constantly adjusted to maintain peak efficiency of the turbine as the prevailing wind speed changes.

In a preferred embodiment, the synchronous induced wind power generation of the first embodiment above is provided, wherein the interior area of the turbine-generator section between the air inlet shroud and the air discharge shroud is smaller than the areas of the air inlet and air discharge shrouds at their largest (anterior) areas, whereby the air inlet shroud funnels air into the turbine-generator section, and the air discharge shroud induces a negative air pressure, thereby creating an induced differential pressure across the wind turbine. Further, preferably, the air discharge shroud has a larger discharge area than the air inlet shroud, which may serve to aid the wind vane effect that aids in keeping the air inlet shroud pointed into the prevailing wind.

More preferably, the anterior area of the air discharge shroud is 1.1 to 16 times larger than the interior area of the turbine-generator section. Further, the anterior area of the air discharge shroud is 8 to 13 times larger than the interior area of the turbine-generator section. Most preferably, the anterior area of the air discharge shroud is about 12 times larger than the interior area of the turbine-generator section. In each preferred embodiment, the area of the air inlet shroud at its largest (anterior) area is smaller than the area of the air discharge shroud at its anterior area, and the anterior area size ratio between the air inlet and air discharge shrouds is adjusted to optimize the air differential pressure.

In a further preferred embodiment, the synchronous induced wind power generation system of the first embodiment above is provided, further comprising a computer program product (computer software application) for managing operation of the wind power generation system. This computer program product is comprised of computer usable program code operable to enable the computer processor to communicate with one or more of the various sensors, to synchronize frequency and voltage phase of the generator units with the external power line in communication with the system, and to control operation of the turbine magnetic brakes and the pitch of the adjustable pitch directrix blades so as to limit the maximum power delivered to the generator during both high wind conditions and during wind gusts. This functionality is achieved via the removably disposed permanent magnets which act to limit shaft power to the turbine, that can be deployed during high wind conditions and during loss of load conditions via the electromagnets operable to achieve the rapid response times required to handle wind gusts, and via varying of the pitch of the adjustable pitch directrix blades so as to adjust the range of torque that the turbine can deliver to the generator.

Further, the computer usable program code is operable to control the turbine magnetic brakes and the pitch of the adjustable pitch directrix blades so as to control and monitor the speed of rotation of the turbine, especially during initial synchronization with the power line and during loss of load, when the load is suddenly removed and the magnetic brakes must supply braking action equivalent to 100% of the generator's output at the instant that the load is lost and attempt to maintain the phase of the line in case the load returns a few seconds later.

Further, the computer usable program code is operable to control the status of the 3-phase AC power switch (breaker) between the generator and the external power line, the field current of the synchronous generator to control VAR (volt-amps reactive) generation during normal operation, and the interruption of field current immediately before opening the breaker, especially when instantaneous overcurrent is detected and an immediate shutdown is required.

In another preferred embodiment, the synchronous induced wind power generation system of the first embodiment above is provided, further comprising one or more controllable, pivotable air bypass (relief) doors disposed in the air discharge shroud, which may open as needed to allow air to freely pass through areas of the air discharge shroud, so as to limit the stress on the entire structure and reduce the differential air pressure across the turbine-generator unit during high wind conditions. Preferably, these air bypass doors open inward, into the interior volume of the air discharge shroud.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

FIG. 1 is a perspective view of the synchronous induced wind power generation system of the present invention.

FIG. 2 is a side view of the synchronous induced wind power generation system of the present invention.

FIG. 3 is a partial cross-sectional view of the synchronous induced wind power generation system of the present invention, illustrating the internal configuration of the turbine-generator section having the turbine-generator disposed therein.

FIG. 4 is a partial cross-sectional view of the synchronous induced wind power generation system of the present invention, illustrating one preferred disposition of the turbine-generator unit, turbine brakes relative to the turbines, and adjustable pitch directrix blading.

FIG. 5 is a box diagram illustrating the connectivity of the various components of the control system of the system of the present invention.

FIG. 6 is a partial cross-sectional view of the synchronous induced wind power generation system of the present invention, illustrating the disposition of the turbine blades and magnetic brake rotor thereof relative to the permanent magnet and system for engagement thereof with the magnetic brake rotor.

FIG. 7 is a partial cross-sectional view of the synchronous induced wind power generation system of the present invention, illustrating the disposition of the turbine blades and magnetic brake rotor thereof relative to the turbine brakes and electromagnet braking system.

FIG. 8 is a partial cross-sectional view of the synchronous induced wind power generation system of the present invention, illustrating the magnetic forces applied to the magnetic brake rotors to brake the spinning of the turbine blades.

FIG. 9 is a partial perspective view of the synchronous induced wind power generation system of the present invention, illustrating the disposition of the adjustable pitch directix blades relative to the turbine blades.

FIG. 10 is a partial side view of the synchronous induced wind power generation system of the present invention, illustrating the disposition of the adjustable pitch directrix blading relative to the turbine blades during “load shedding” operation, wherein the pitch of the adjustable pitch directrix blading is varied so as to reduce turbine power.

FIG. 11 is a partial cross sectional view of the synchronous induced wind power generation system of the present invention, illustrating the disposition of the adjustable pitch directrix blading relative to the turbine blades during “normal” operation, wherein the pitch of the adjustable pitch directrix blading is varied so as to enhance turbine power.

### DETAILED DESCRIPTION OF THE INVENTION

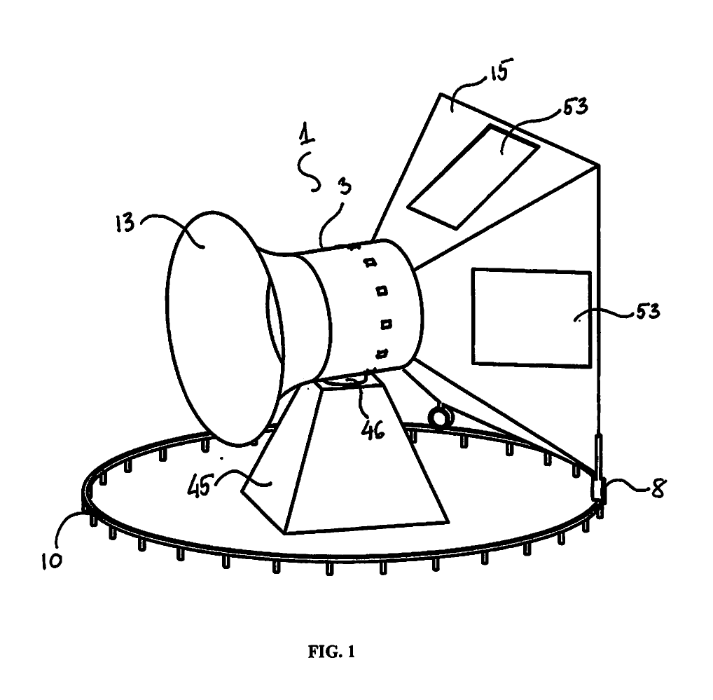

As illustrated in FIGS. 1-3, a synchronous induced wind power generation system 1 is provided that may be conveniently deployed in urban environments, such as on the tops of flat roofed buildings. In fact, this abundantly available urban area is one of the most advantageous locations for placement due to the higher ambient winds flowing over the roof caused by the building itself. Advantageously, elements of the system 1 are operable to limit the maximum stress applied to the building on which the system 1 is mounted, such that the force applied against the building does not rise with the cube of wind speed after the unit reaches 100% power, as might otherwise be expected.

Further, the low noise level produced by the system 1 of the present invention during operation thereof is unobtrusive to occupants and neighbors. The electrical load of the building below can be partially met by the system of the present invention by converting the otherwise unused wind energy flowing across the roof into electrical power. Further, using the existing building as a site for this invention negates the cost of building any high structure to take advantage of the higher wind speeds at greater heights above ground level.

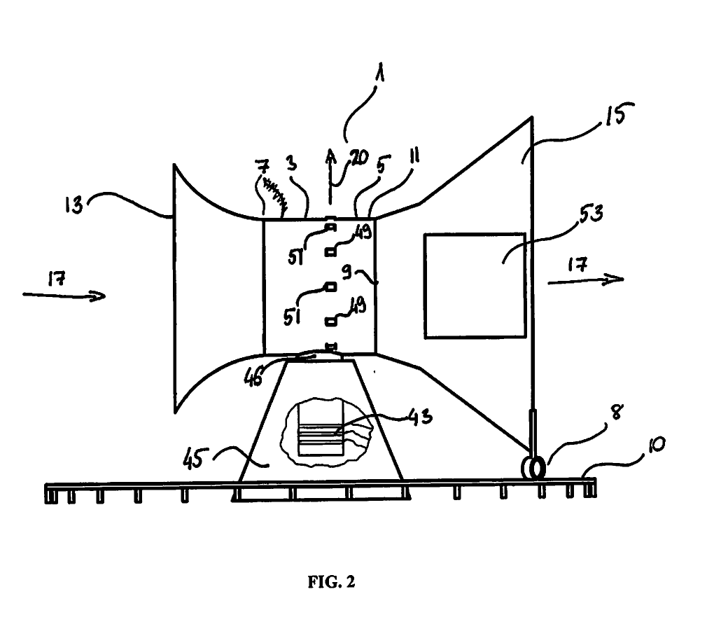

In particular, as shown in FIGS. 1-5, the present invention provides a synchronous induced wind power generation system 1 comprised generally of a turbine-generator section 3, a turbine-generator unit 21 disposed therein, a direction orientation means comprised of a pivot 46 on a support base 45 or “lazy Susan” turntable affixed to the turbine-generator section 3 to allow the entire system 1 to rotate with wind vaning torque to orient itself such that the wind will directly enter the air inlet shroud 13 in connection with the turbine-generator section 3, supported by wheels 8 on a circular track 10, and a control system 33 operable to control the entire system 1 based on, for example, wind velocity, external load characteristics, power requirements, etc. As illustrated in FIG. 2, the support base 45 contains 3-phase AC power slip rings 43 to commutate the generated power to an external power line (not shown).

Specifically, as shown in FIGS. 1 and 2, the turbine-generator section 3 is comprised of an outer shell 5 having a first end 7, a second end 9 opposite the first end 7, and an interior area 11 disposed there between. An air inlet shroud 13 is disposed at the first end 7, an air discharge shroud 15 is disposed at the second end 9 opposite the first end 7, a wind flow axis 17 extends from the air inlet shroud 13 to the air discharge shroud, and an axis of rotation 20 disposed perpendicular to the wind flow axis 17. The turbine-generator section 3 may be formed in any shape, such as round, conical, square or rectangular shape, a variation thereof, as well as two or more of same.

In a preferred embodiment, as illustrated in FIGS. 1 and 2, the area adjacent the turbine-generator section 3 defined by the air discharge shroud 15 is larger than the area adjacent the turbine-generator section 3 defined by the air inlet shroud 13 adjacent the interior area 11, so as to induce a higher differential air pressure across the turbine-generator section, thereby increasing wind flow through the turbine-generator section 3 and allowing initial power generation in relatively light wind velocities. Preferably, the anterior area of the air discharge shroud 15 is 1.1 to 12 times larger than the area of the turbine-generator section 3 interior area 11, more preferably, 5 to 8 times larger than the area of the turbine-generator section 3 interior area 11, most preferably about 12 times larger than the area of the turbine-generator section 3 interior area 11

The anterior area of the air inlet shroud 13 is preferably smaller than the anterior area of the air discharge shroud 15. This configuration enables the creation of induced differential air pressure, which allows the system 1 to begin to produce meaningful power at lower ambient air speeds than conventional wind power generators.

By forming the turbine-generator section with an air discharge shroud 15 having a larger anterior area than the interior area 11 of the turbine-generator section 3, and an air inlet shroud with an anterior area larger than the interior area 11 of the turbine-generator section 3, a pair of coaxial “funnels” are formed. Thus, wind that is blowing horizontal to the ground can blow through one end of the turbine-generator section 3 and exit out the other end. The exit end (air discharge shroud 15) induces a negative pressure from the wind blowing past it. The upwind end (air inlet shroud 13) forms a positive pressure from the wind against it. The differential pressure between the two shrouds 13, 15 causes a substantial increase in wind velocity through the interior area 11 of the turbine-generator section 3, and hence an increased wind velocity over the turbine blades 23 disposed therein. The shrouding, rather than a bare turbine without shrouding, is preferred so as to allow for a small, high speed turbine that is directly coupled to a generator without losing the ability to arrest large amounts of energy from the passing wind.

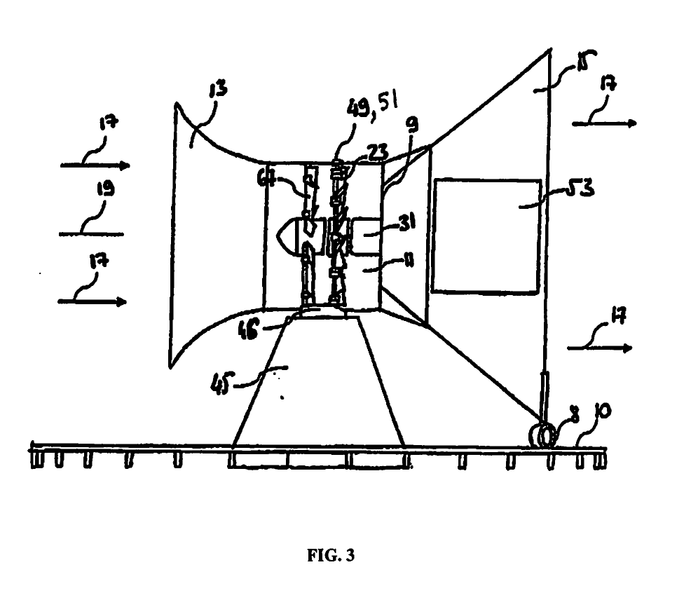

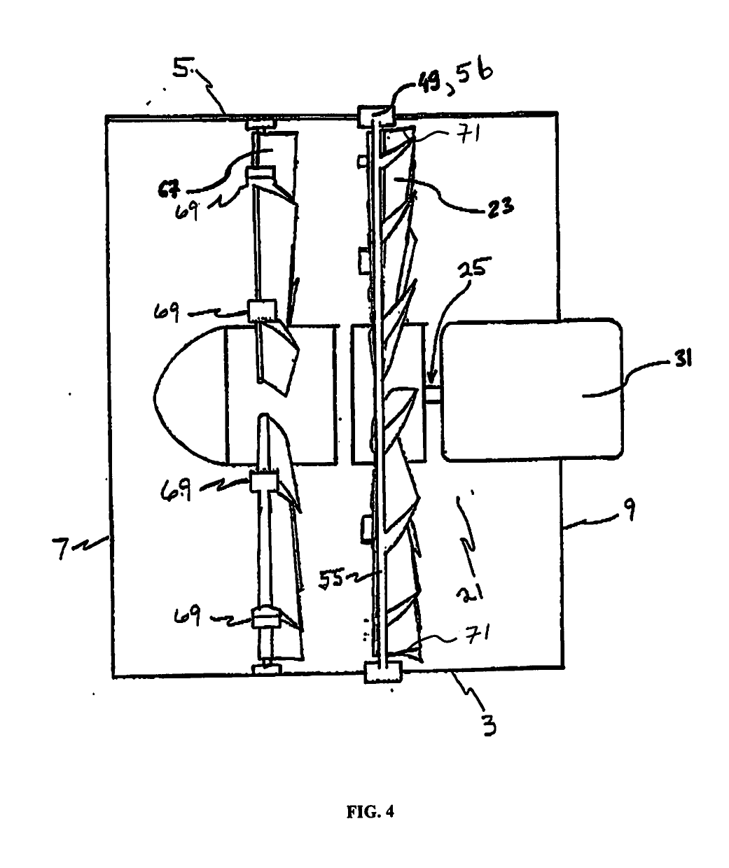

Specifically, as shown in FIGS. 3 and 4, the turbine/generator unit(s) 21 is disposed within the interior area 11 of the turbine-generator section 3 at or between the air inlet shroud 13 and the air discharge shroud 15. The turbine/generator section 3 is comprised of one or more turbine blades 23, a rotatable shaft 25 in connection therewith, and a synchronous AC generator 31 in connection with the rotatable shaft 25 opposite the turbine blades 23. Preferably, the turbine blades 23 are disposed in a plane perpendicular or approximately perpendicular with the axis of rotation 19.

As illustrated in FIGS. 4 and 6-8, one or more turbine brakes are disposed on or adjacent to the turbine blades 23. The turbine brakes, which are in communication with the control system 33 so as be operated thereby, are comprised of metallic brake rotor(s) 55 and turbine brake permanent magnets 56 or electromagnets 49 contained in housing 52. As illustrated in FIG. 7, these electromagnets may be any conventional form of electromagnet wherein magnetic forces are exerted via an electrical current flowing through a winding coil.

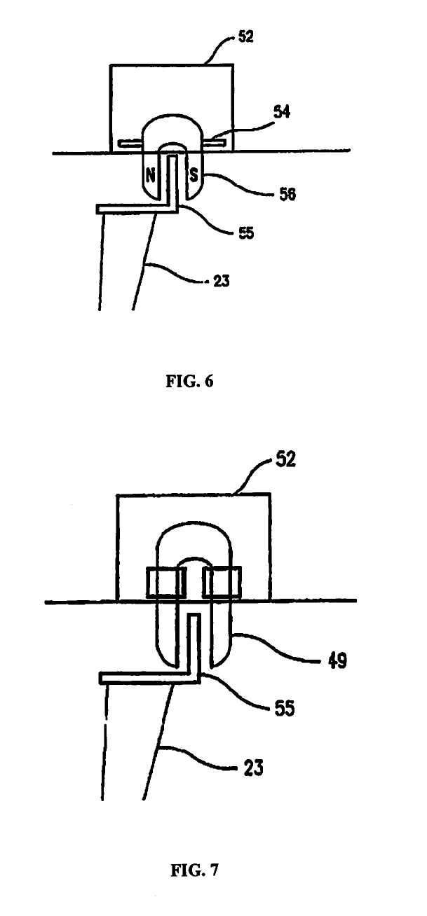

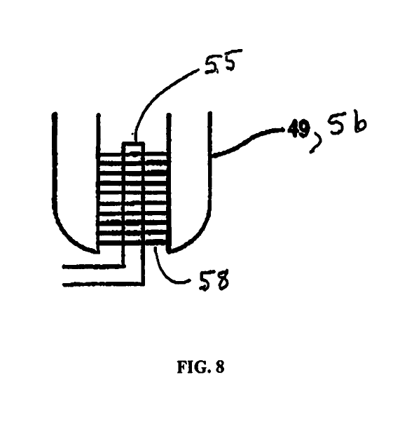

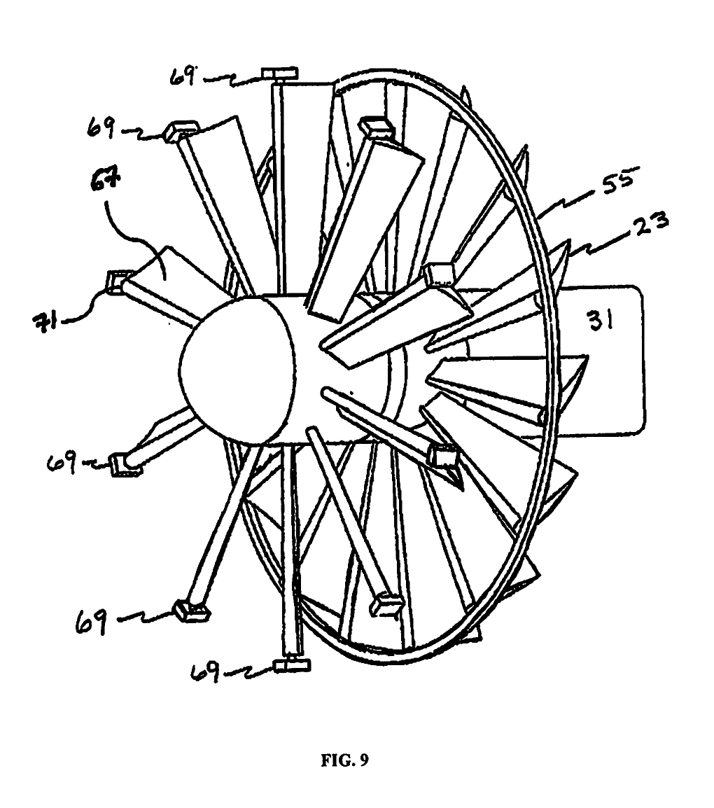

In addition, preferably, the turbine brakes comprise permanent magnets 56, which are movably disposed adjacent the metallic brake rotor(s) 55. For example, a pivot mechanism 54 may be utilized to move the permanent magnet within a distance operable to induce magnetic forces on the magnetic brake rotor. The permanent magnets 56, as illustrated in FIG. 6, which may be housed in housing 52 are operable to induce magnetic lines of flux through the magnetic brake rotor 55, as illustrated in FIG. 8, so as to induce braking action on the turbine blades 23.

The magnetic brakes allow precise control of the turbine torque delivered to the generator, as well as control of turbine rotational speed when the turbine-generator unit 21 is off-line. Further, the magnetic turbine brakes, which are in conductive or mechanical communication with the control system 33, are used to control the speed and phase of rotation during start-up synchronization, the maximum speed of rotation of the turbine blades 23 with no load, and the torque delivered to the generator during synchronous operation of the turbine generator unit 21, thereby controlling or limiting shaft power delivered to the synchronous generator 31.

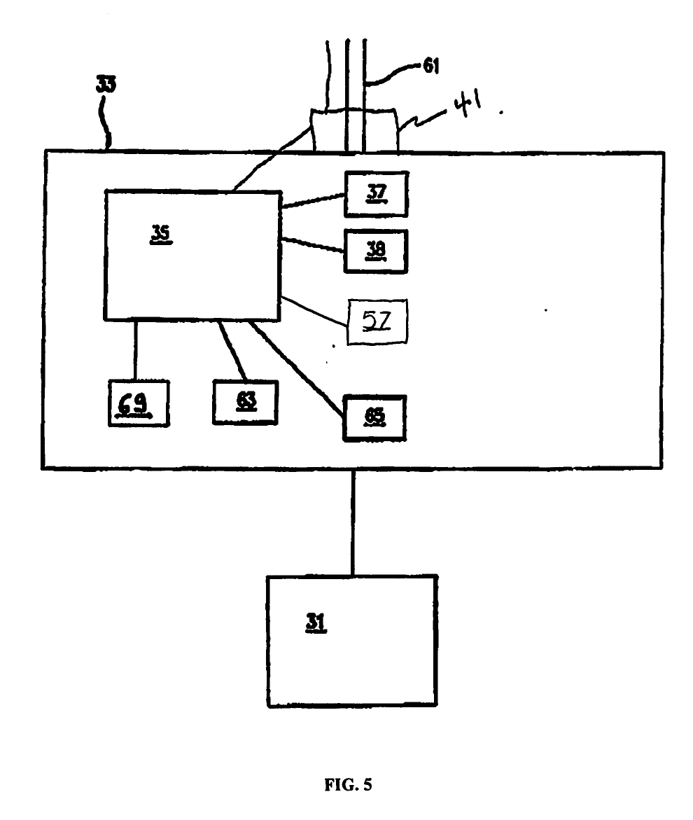

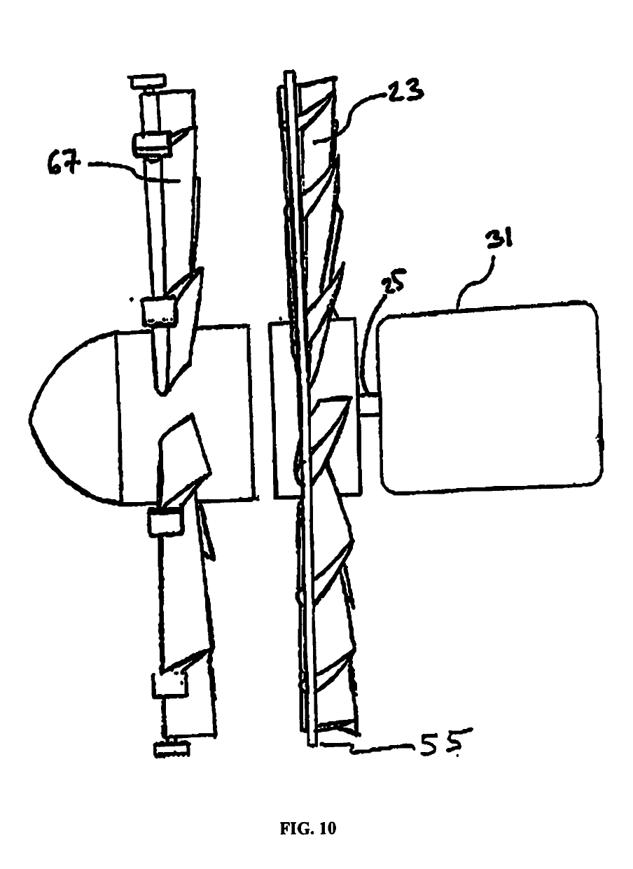

Further, as illustrated in FIGS. 3-4 and 9-11, adjustable pitch directrix blading 67 is provided, disposed in a plane perpendicular to the rotatable shaft 25, each of the adjustable pitch directrix blades 67 having one or more outer tips 71 about which the blades 67 are pivotable. The adjustable pitch directrix blades 67 are in communication with the servo controller 69, as illustrated in FIGS. 5 and 9, which acts to vary the pitch of the blades 67 as needed.

For example, as illustrated in FIG. 11, at power levels below 100%, the pitch of the adjustable pitch directrix blades (in plural, blading) 67 turns the inlet air (i.e., the air flowing into the turbine-generator section from outside of the system) in the direction of rotation of the turbine blades 23, and is adjusted to optimize turbine power. As wind speed increases turbine shaft power above 100%, and below about 125% of the generator's power rating, the electromagnetic 49 and permanent magnet 56 turbine magnetic brakes are employed to keep the generator at 100% loading.

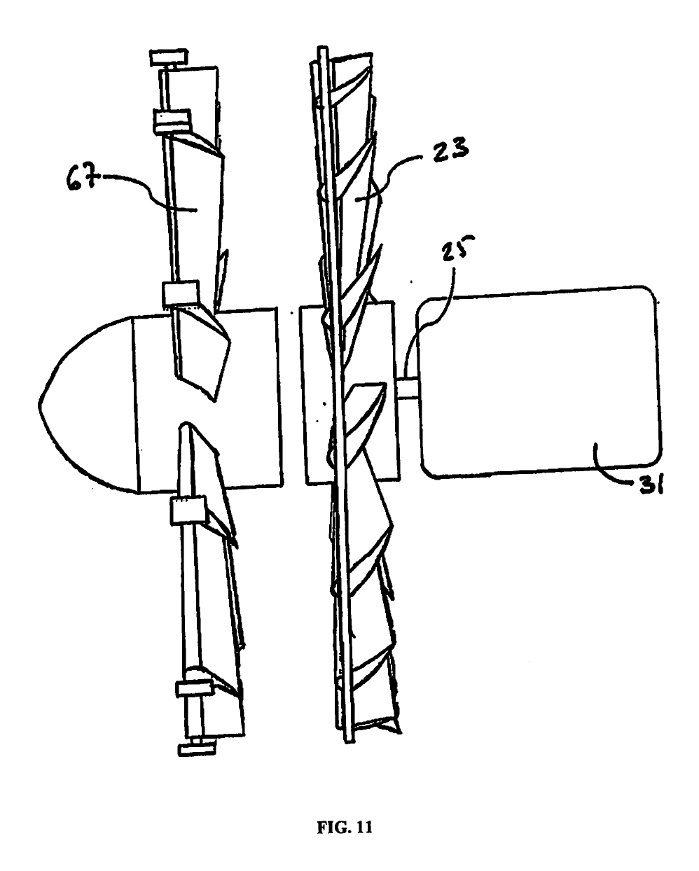

As wind speed further increases, the pitch of the adjustable pitch directrix blading 67 is decreased, thus redirecting the flow of incoming air in a direction less correspondent to the rotation of the turbine blades 23, thereby limiting turbine power to around 125%. As wind speed further increases, the pitch of the adjustable pitch directrix blading 67 can be adjusted to turn the inlet air in the opposite direction of rotation of the turbine blades 23, as illustrated in FIG. 10, to prevent the turbine power from exceeding 125% of the generator's power rating. This mode, which is used to prevent the wind power of the turbine from exceeding about 125% of the rated generator power, is referred to as “beta” pitch (turning the incoming air in the opposite direction of the turbine).

The permanent magnets 56 are also deployed (moved within magnetic range of the magnetic brake rotors 55) as needed to shed wind power in higher winds, and to keep the electrical generation from exceeding 100% power output. To limit the stress on the structure during higher wind speeds, the pivotable air bypass doors 53, which are in communication with the control system 33, open inwardly into the interior area of the air discharge shroud 15 as needed, as illustrated in FIG. 1. Further, more of the permanent magnets 56 can be moved into position (adjacent to the metallic brake rotor(s) 55) to maintain the generator output power at around 100%, and the electromagnets are primarily used for controlling power delivered to the generator during wind gusts.

As mentioned above, and as illustrated in FIG. 5, a control system 33 is provided in conductive communication with each synchronous generator 31 so as to be operable to synchronize the frequency and the voltage phase of the synchronous generator 31 with the voltage and phase of an external AC power line 61 in conductive communication with the synchronous generator during startup. In a preferred embodiment, a voltage regulator 63 is provided in communication with the computer processor to control the field current of the generator. The turbine generator unit rotates at one fixed (predetermined) synchronous speed when generating electrical power. This one fixed operating speed is mainly dependent on turbine diameter. The fixed turbine operating speed determines the number of poles required for the generator to produce 60 hertz power (or any other frequency power). For example, a 450 RPM turbine requires a 16-pole synchronous generator to produce 60 hertz power, and the 450 RPM speed equates to a turbine tip speed of 471 feet per second for a 10-foot diameter turbine, and that is adequate speed to facilitate the operation of the magnetic brakes at the turbine tips. And the turbine is designed to optimize its efficiency at the synchronous speed of the generator.

The ability to choose a generator to match the speed of the turbine desirably allows for direct drive, rather than a geared drive, thereby simplifying the design and minimizing the cost of construction. The turbine is designed to optimize energy transfer at the synchronous speed of the generator. The synchronous generator 31 runs synchronized with the power line when operating, and generates 60 hertz AC power (for US applications) at any power factor desired, such that the AC output voltage can be regulated by controlling the field current of the generator. Thus, the synchronous generator 31 of the present invention can produce VARS to create any Power Factor within the operating range of the generator.

During start-up, the magnetic brakes are used to absorb all turbine power until some predetermined minimum power level (perhaps 5%) is achieved, while holding the turbine speed at approximately the synchronous speed of the generator. This is preferably achieved by inserting/providing a sufficient amount of permanent magnets 56 to allow turbine speed to reach synchronous speed while absorbing enough energy to equal some predetermined minimum power level of the generator's power rating. Thus, when the turbine speed reaches synchronous speed and that minimum power level has been achieved, and the unit can be brought on line. At that point, the electromagnets are activated as the permanent magnets are removed (i.e. moved to a location wherein no magnetic force is exerted on the magnetic brake rotors), and the braking is adjusted until the turbine is running at synchronous speed. Then, the exciter, an electromagnet that produces the magnetic field that rotates inside the stator of the generator, is energized so as to cause AC voltage output of the generator to match the voltage of the external electrical power grid.

The magnetic brakes are used to adjust the phase of the generator to match the phase of the external electrical power grid, then the unit breaker 41 is closed to connect the synchronous generator 31 to the external electrical power grid. The magnetic brakes are then released, allowing the power that was being absorbed by the magnetic brakes to reach the generator. If the generator power falls below about 1%, the unit breaker 41 is opened and the magnetic brakes resume controlling the maximum speed of the turbine.

The control system 33 is comprised of a computer processor 35. The computer processor 35 may be any conventional computer, such as a desktop computer, a laptop computer, or any computing mechanism that performs operations via a microprocessor, which is a programmable digital electronic component that incorporates the functions of a central processing unit (CPU) on a single semi-conducting integrated circuit (IC). One or more microprocessors typically serve as the CPU in a computer system, embedded system, or handheld device.

A data processing system suitable for storing and/or executing program code includes at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

The control system 33 is further comprised of one or more of a phase sensor 37 and speed sensor 38, both of which are in connection with the computer processor 35 and each of the synchronous generators 31. The phase sensor 37 and speed sensor 38 are preferably one or more of a voltage sensor, an optical sensor, a mechanical sensor, or a magnetic sensor. Further, a turbine brake electromagnets and permanent magnets controller 57 is in communication with the computer processor 35, said turbine brake electromagnets and permanent magnets controller operable to control the application of magnetic breaking force upon the turbine blades 23. In addition, in a preferred embodiment, one or more differential pressure sensors 65 are provided in communication with the computer processor 35 to determine the wind power of the turbine at all times. The wind power of the turbine is the sum of the power delivered to the generator plus the power absorbed by the magnetic brakes.

The phase sensor(s) 37 are operable to sense the electrical phase of the generator with respect to the external AC line as well as turbine-generator speed prior to connection with the external AC line. The speed sensor 38 measures the rotational speed of the turbine-generator assembly. Data is recorded by each of these sensors/detectors, and fed to the computer processor 35 for use/analysis by the control system 33 in determining proper operating parameters of the system 1. In addition, as mentioned above, the control system further comprises a servo controller 69, as shown in FIG. 5, which is in communication with the computer processor 35 and the adjustable pitch directrix blades 67, the servo controller being operable to vary the pitch of the adjustable pitch directrix blades 67, as illustrated in FIG. 4.

In a further preferred embodiment, as illustrated in FIGS. 1-3, one or more pivotable air bypass doors 53, as mentioned above, are disposed in or adjacent to the air discharge shroud 15. These doors 53, which are preferably in communication with the control system 33 via mechanical, electrical or hydraulic means, may be opened proportionally to limit the stress on the entire structure 1, and/or to reduce air differential pressure across the wind turbine during high ambient wind conditions. In particular, when the control system 33 determines that the available wind energy has exceeded a predetermined desirable level, the pivotable air bypass doors 53 may be fully or partially opened to limit air flow through the turbine-generator unit 21. Preferably, the doors 53 are opened inwardly into the interior of shroud 15, so as to reduce the differential air pressure across the turbine and to limit the maximum stress applied to the entire structure 1 by the wind. Thus, there are four variables that must be controlled to work together: 1) the pitch of the adjustable pitch directrix blading, 2) the position of the permanent magnets around the magnetic brake rotor, 3) the current applied to electromagnetic coils, and 4) the position of the air bypass doors.

The synchronous induced wind power generation system 1 of the present invention further comprises a computer program product for managing operation of the wind power generation system, and method of operating the wind power generation system via use of same. The computer program product is stored on a computer-usable or computer readable medium which may be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, a removable FLASH memory medium, a random access memory (RAM), a read-only memory (ROM), a rigid magnetic disk and an optical 16 disk. Current examples of optical disks include compact disk—read only memory (CD-ROM), compact disk—read/write (CD-R/W) and DVD.

The computer usable medium has computer usable program code embodied thereon, the computer usable program code comprising various code operable to control the operation of the system 1. In particular, in a first embodiment, the computer usable program code is operable to enable the computer processor to communicate with one or more differential air pressure sensors and phase sensors, so as to receive and store data therefrom. Further, computer usable program code is operable to enable the control system 33 to synchronize frequency and voltage phase of the synchronous generator 31 with the voltage phase of an external AC power line 61 in communication with the system 1.

In a further preferred embodiment, the computer program of the present invention is further operable to control the electromagnetic brakes 49 to modulate shaft power delivered to the generator(s) units 31 during wind transients and to control the pitch of the adjustable pitch directrix blades 67 to control turbine power and so as to prevent instantaneous overloads of the generator units 31, to control the speed of the generator units 31 during loss of external electrical load of the generator units 31 via application of the electromagnetic brakes 49, to control voltage of the generator units 31 during normal operation and at the moment of loss of external electrical load of the generator units, and to monitor and redirect mechanical loads of greater than 100% of full generator power to the electromagnetic brakes after loss of external electrical load, so as to maintain the turbines at full speed for a short time until the external electrical load is restored, thereby allowing the generator to quickly resume power generation after short load interruptions.

Thus, the computer program product provides the following general functionality:

(1) communication of the computer processor 35 with one or more of the various sensors;

(2) synchronization of the voltage and phase of the generator units 31 with the voltage and phase of an external power line in communication with the system;

(3) control of the 3-phase AC power switch (breaker); and

(4) control of the turbine magnetic brakes so as to control and monitor the speed of rotation and phase of the generator, and the torque applied to the generator.

Further, the computer program is operable to enable the control system 33 to control operation of the turbine magnetic brakes 49 (electromagnetic) and 56 (permanent magnets), and the pitch of the adjustable pitch directrix blading 67 via a servo controller in communication with the computer processor 35 and the adjustable pitch directrix blades 67. In another preferred embodiment, the computer program is also operable to enable the control system 33 to control operation (opening and closing) of the pivotable air bypass doors 53.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

### LIST OF DRAWING ELEMENTS

1: synchronous induced wind power generation system
3: turbine-generator section
5: outer shell of turbine-generator section
7: first end of turbine-generator section
8: air discharge shroud support wheel on circular track
9: second end of turbine-generator section
10 circular track for air discharge support wheels
11: interior area of turbine-generator section
13: air inlet shroud
15: air discharge shroud
17: wind flow axis
19: axis of turbine shaft rotation
20: axis of rotation of turbine-generator section
21: turbine/generator unit
23: turbine blades
25: rotatable shaft
31: synchronous generator
33: control system
35: computer processor
37: phase sensor
38: speed sensor
41: 3-phase AC power switch (breaker)
43: 3-phase power slip rings
45: direction orientation means support pedestal
46: vertical shaft for direction orientation means (pivot)
49: turbine brake electromagnets (electromagnetic brakes)
52: housing
53: pivotable air bypass door
54: permanent magnet pivot
55: magnetic brake rotor
56: turbine brake permanent magnet
57: turbine brake electromagnets and permanent magnets controller
58: magnetic lines of flux
61: external AC line
63: voltage regulator
65: differential pressure sensor
67: adjustable pitch directrix blades
69: servo controller to control directrix blades pitch
71: tips of adjustable pitch directrix blades

What is claimed is:

1. A synchronous induced wind power generation system comprising:
(a) a turbine-generator section comprised of an outer shell having a first end, a second end opposite the first end, an interior area disposed there between, an air inlet shroud disposed at the first end, an air discharge shroud disposed at the second end, a horizontal wind flow axis extending from the air inlet shroud to the air discharge shroud, and a vertical axis of rotation disposed perpendicular to the wind flow axis;
(b) one or more turbine/generator units disposed within the interior area of the turbine-generator section at or between the air inlet shroud and air discharge shroud, each of said turbine/generator units comprised of:
(i) a horizontally disposed rotatable shaft having a first end and a second end;
(ii) one or more turbine blades disposed in a plane perpendicular to the rotatable shaft and in connection with the first end of the rotatable shaft, each of said turbine blades having one or more outer tips;
(iii) a synchronous generator in communication with the second end of the rotatable shaft;
(iv) one or more turbine magnetic brake rotor(s) disposed on one or more turbine blade outer tips;
(v) one or more adjustable pitch directrix blades disposed in a plane parallel to the one or more turbine blades; and
(vi) one or more slip rings (which may be any conventional slip ring) disposed on or adjacent to a direction orientation means support pedestal, said slip rings operable to commutate the 3-phase AC power switch of the turbine-generator section to an external AC power line;
(c) a control system in conductive communication with each synchronous generator operable to synchronize the frequency, phase and voltage of the synchronous generator with the frequency, phase and voltage of an external AC power line in conductive communication with the synchronous generator, and in conductive or mechanical communication with the turbine magnetic brakes and adjustable pitch directrix blading so as to be operable to control the speed of rotation with no load, or maximum torque during synchronous operation of the turbine, thereby controlling shaft power delivered to the generator, said control system comprised of:
(i) a computer processor;
(ii) one or more of a phase sensor and speed sensor in connection with the computer processor and each of the turbine/generator units;
(iii) one or more electromagnets disposed adjacent to the magnetic brake rotor and in communication with the computer processor;
(iv) one or more permanent magnets removably disposed on the turbine generator section adjacent a periphery thereof and the magnetic brake rotor, and in communication with the computer processor;
(v) a servo controller in communication with the computer processor and the adjustable pitch directrix blades, the servo controller operable to vary the pitch of the adjustable pitch directrix blades;
(vi) one or more voltage, current, frequency and phase sensors in communication with the external AC power line so as to measure the voltage, current, frequency and phase thereof (vii) a 3 phase AC power switch in communication with the computer processor, said switch operable to open or close the AC connection between the generator and the external power line; and
(viii) a voltage regulator in communication with the computer processor, said voltage regulator operable to adjust the field current in the generator.

2. The synchronous induced wind power generation system of claim 1, wherein the anterior area of the air inlet shroud and the anterior area of the air discharge shroud are larger than the interior area of the turbine-generator section, thereby funneling air into the interior area of the turbine-generator section and inducing a negative air pressure at the air discharge end of the turbine-generator section to create a higher differential air pressure across the turbine-generator section.

3. The synchronous induced wind power generation system of claim 1, wherein a horizontal pivot of rotation is forward toward the air inlet shroud, thereby enabling the turbine generator section to wind vane into the wind so as to orient the air inlet shroud in an upwind disposition relative to the air discharge shroud.

4. The synchronous induced wind power generation system of claim 2, wherein the anterior area of the air discharge shroud is 1.1 to 16 times larger than the interior area of the turbine-generator section.

5. The synchronous induced wind power generation system of claim 2, wherein the anterior area of the air discharge shroud is 8 to 13 times larger than the interior area of the turbine-generator section.

6. The synchronous induced wind power generation system of claim 2, wherein the anterior area of the air discharge shroud is about 12 times larger than the interior area of the turbine-generator section.

7. The synchronous induced wind power generation system of claim 1, further comprising a direction orientation means in communication with the turbine-generator section, said direction orientation means comprised of a rotatable turntable rotatably affixed to the turbine-generator section operable to allow the turbine generator section to rotate in response to wind vaning torque and orient itself such that the wind will directly enter the air inlet shroud.

8. The synchronous induced wind power generation system of claim 1, wherein the speed sensor is disposed on, adjacent to, or in connection with the rotatable shaft of each of the turbine/generator units, said speed sensor operable to sense the speed of rotation of the shaft.

9. The synchronous induced wind power generation system of claim 1, wherein the speed sensor is comprised of one or more of an optical sensor, mechanical sensor, or magnetic sensor.

10. The synchronous induced wind power generation system of claim 1, wherein the turbine brakes are magnetic brakes comprised of:
(i) one or more non-ferrous metallic brake rotor(s) disposed on or in connection with the turbines, so as to rotate therewith;
(ii) one or more electromagnets statically disposed adjacent to the metallic brake rotor(s), and in conductive communication with the computer processor, said electromagnets operable to induce magnetic lines of flux perpendicular to and through the metallic brake rotor(s), so as to induce braking action in the metallic brake rotor(s); and
(iii) one or more permanent magnets removably disposed adjacent to the metallic brake rotor(s), and in conductive communication with the computer processor, said permanent magnets operable to induce magnetic lines of flux perpendicular to and through the metallic brake rotor(s), so as to induce braking action in the metallic brake rotor(s).

11. The synchronous induced wind power generation system of claim 1, further comprising:
one or more pivotable air bypass doors in communication with the control system, and disposed in or adjacent to the air discharge shroud,
wherein said pivotable air bypass doors are operable to reduce turbine power by reducing the air differential pressure across the turbine, and/or reduce stress applied to the system.

12. The synchronous induced wind power generation system of claim 1, further comprising a voltage regulator in communication with the computer processor.

13. The synchronous induced wind power generation system of claim 1, further comprising a computer program product for managing operation of the wind power generation system, the computer program product comprising:
(a) a computer usable medium having computer usable program code embodied therewith, the computer usable program code comprising:
(i) computer usable program code operable to enable the computer processor to communicate with one or more of the differential pressure sensor and speed sensor;
(ii) computer usable program code operable to synchronize frequency and voltage phase of the generator units with the voltage phase of an external power line in communication with the system;
(iii) computer usable program code operable to enable control of the turbine brakes;
(iv) computer usable program code operable to control the pitch of the adjustable pitch directrix blades; and
(v) computer usable program code operable to control operation of the 3-phase AC power switch.

14. The synchronous induced wind power generation system of claim 14, wherein the computer program product further comprises:
computer usable program code operable to control start-up, operation, and shut-down of the generator as wind conditions change.

15. The synchronous induced wind power generation system of claim 14, wherein the computer usable program code further comprises:
(i) computer usable program code operable to control the magnetic brakes to modulate shaft power delivered to the generator(s) units during wind transients, so as to prevent instantaneous overloads of the generator units;
(ii) computer usable program code operable to control the speed of the generator units during loss of external electrical load of the generator units via application of the magnetic brakes;
(iii) computer usable program code operable to control voltage of the generator units during normal operation and, at a moment of loss of external electrical load of the generator units or instantaneous current overload condition, so as to remove current from the generator field and open the 3-phase AC power switch; and
(iv) computer usable program code operable to monitor and absorb by magnetic braking the mechanical loads of greater than 100% of full generator power from the wind turbines after loss of external electrical load of the generator units, so as to maintain the turbines at full speed until the external electrical load is restored, thereby allowing the generator to recover short line load interruptions in very short time periods.

16. The synchronous induced wind power generation system of claim 13, wherein the computer usable program code further comprises:
(i) computer usable program code operable to control pitch of the one or more adjustable pitch directrix blades via the servo controller.

17. The synchronous induced wind power generation system of claim 1, wherein the synchronous generator runs at a fixed speed so as to produce an AC output synchronous with the power line frequency.
